(19) United States
(12) Patent Application Publication
(10) Pub. No.: US 2025/0125361 A1
(43) Pub. Date: Apr. 17, 2025

(54) SECONDARY BATTERY AND METHOD FOR MANUFACTURING SECONDARY BATTERY

(71) Applicant: MURATA MANUFACTURING CO., LTD., Kyoto (JP)

(72) Inventor: Teppei AKIYOSHI, Kyoto (JP)

(21) Appl. No.: 18/999,180

(22) Filed: Dec. 23, 2024

Related U.S. Application Data
(63) Continuation of application No. PCT/JP2023/035909, filed on Oct. 2, 2023.

(30) Foreign Application Priority Data
Nov. 11, 2022 (JP) 2022-181012

(51) Int. Cl. H01M 4/62; H01M 4/02

(52) U.S. Cl. CPC H01M 4/621; H01M 2004/028

(57) ABSTRACT

A secondary battery of the present disclosure includes a stacked electrode assembly in which a plurality of positive electrodes and a plurality of negative electrodes are alternately stacked with a separator interposed therebetween. The positive electrodes include a positive electrode metal current collector, a positive electrode active material layer stacked on the positive electrode metal current collector, and an adhesive layer adhering to the separator. A region of the positive electrode metal current collector where the positive electrode active material layer is not stacked forms a positive electrode metal current collector exposed portion. An edge portion of the positive electrode active material layer includes a first edge portion adjacent to the positive electrode metal current collector exposed portion and a second edge portion disposed on a side opposite to the first edge portion when viewed from a stacking direction in which the positive electrode and the negative electrode are stacked. The adhesive layer includes a first adhesive layer stacked on the positive electrode metal current collector exposed portion and extending along the first edge portion, and a second adhesive layer extending along the second edge portion.

### CROSS REFERENCE TO RELATED APPLICATIONS

The present application is a continuation of PCT patent application no. PCT/JP2023/035909, filed on Oct. 2, 2023, which claims priority to Japanese patent application no. 2022-181012, filed on Nov. 11, 2022, the entire contents of which are incorporated herein by reference.

### BACKGROUND

The present disclosure relates to a secondary battery and a method for manufacturing the secondary battery.

An electrode assembly of a secondary battery includes a positive electrode, a negative electrode, and a separator interposed between the positive electrode and the negative electrode. The positive electrode includes a positive electrode metal current collector and a positive electrode active material layer stacked on the positive electrode metal current collector. A part of the positive electrode metal current collector is not stacked with the positive electrode active material layer, and constitutes a positive electrode metal current collector exposed portion connected to a tab. A wound electrode assembly is disclosed in which a positive electrode, a negative electrode, and a separator are stacked, and the stacked stack is wound.

### SUMMARY

The present disclosure relates to a secondary battery and a method for manufacturing the secondary battery.

Incidentally, examples of the electrode assembly include a stacked electrode assembly in addition to the wound electrode assembly. In the stacked electrode assembly, a plurality of positive electrodes and a plurality of negative electrodes are alternately stacked with a separator interposed therebetween. In such a stacked electrode assembly, when an adhesive layer is provided on the positive electrode metal current collector exposed portion, there is a possibility that positional deviation between the separator and the positive electrode occurs at a portion on the opposite side of the positive electrode metal current collector exposed portion.

In an embodiment, the present disclosure relates to providing a secondary battery and a method for manufacturing the secondary battery, which can suppress positional deviation between a separator and a positive electrode in a portion on an opposite side of a positive electrode metal current collector exposed portion.

A secondary battery according to a first aspect of the present disclosure includes a stacked electrode assembly in which a plurality of positive electrodes and a plurality of negative electrodes are alternately stacked with a separator interposed therebetween. The positive electrode includes a positive electrode metal current collector, a positive electrode active material layer stacked on the positive electrode metal current collector, and an adhesive layer that adheres to the separator. A region of the positive electrode metal current collector where the positive electrode active material layer is not stacked forms a positive electrode metal current collector exposed portion. An edge portion of the positive electrode active material layer includes a first edge portion adjacent to the positive electrode metal current collector exposed portion when viewed from a stacking direction in which the positive electrode and the negative electrode are stacked and a second edge portion disposed on a side opposite to the first edge portion. The edge portion of the positive electrode active material layer includes a first edge portion adjacent to the positive electrode metal current collector exposed portion when viewed from a stacking direction in which the positive electrode and the negative electrode are stacked and a second edge portion disposed on a side opposite to the first edge portion. The adhesive layer includes a first adhesive layer stacked on the positive electrode metal current collector exposed portion and extending along the first edge portion, and a second adhesive layer extending along the second edge portion.

A method for manufacturing a secondary battery according to a second aspect of the present disclosure includes an intermediate stack manufacturing step of manufacturing an intermediate stack in which a positive electrode intermediate sheet and a negative electrode intermediate sheet are alternately stacked with a separator intermediate sheet interposed therebetween, and a segmentation step of segmenting the intermediate stack and manufacturing a stack in which a positive electrode and a negative electrode are alternately stacked with a separator interposed therebetween. The positive electrode intermediate sheet includes a plurality of positive electrode metal current collector bodies arranged in one direction along the separator intermediate sheet, a connecting portion that protrudes in the one direction from an edge portion of the positive electrode metal current collector body, is connected to the positive electrode metal current collector body disposed in the one direction, and is cut in the segmentation step, a plurality of positive electrode active material layers stacked on a plurality of the positive electrode metal current collector bodies, and an adhesive layer that adheres to the separator intermediate sheet. The edge portion of the positive electrode active material layer includes a first edge portion adjacent to the connecting portion disposed in the one direction, and a second edge portion adjacent to the connecting portion disposed in a direction opposite to the one direction. The adhesive layer includes a first adhesive layer stacked on the connecting portion and extending along the first edge portion, a cutting adhesive layer stacked on the connecting portion and extending along the second edge portion. In the segmentation step, the cutting adhesive layer is cut, and the cutting adhesive layer is divided into a second adhesive layer disposed in the one direction and a third adhesive layer disposed in the opposite direction.

According to the present disclosure, in an embodiment, positional deviation between a separator and a positive electrode is suppressed in a portion on an opposite side of a positive electrode metal current collector exposed portion.

### BRIEF DESCRIPTION OF THE FIGURES

FIG. 1 is a sectional view of a stacked electrode assembly of a secondary battery according to an embodiment, and is specifically a sectional view taken along line I-I in FIG. 2.

FIG. 2 is a view of a stack of an embodiment as viewed from a stacking direction.

FIG. 3 is a view of a negative electrode of an embodiment as viewed from the stacking direction.

FIG. 4 is a view of a separator of an embodiment as viewed from the stacking direction.

FIG. 5 is a view of a positive electrode of an embodiment as viewed from the stacking direction.

FIG. 6 is a view of a positive electrode of an embodiment as viewed from the stacking direction.

FIG. 7 is a view of a positive electrode of an embodiment as viewed from the stacking direction.

FIG. 8 is a view of a positive electrode of an embodiment as viewed from the stacking direction.

FIG. 9 is a view of a negative electrode of an embodiment as viewed from the stacking direction.

FIG. 10 is a view of a separator of an embodiment as viewed from the stacking direction.

FIG. 11 is a view of a negative electrode of an embodiment as viewed from the stacking direction.

FIG. 12 is a view of a positive electrode of an embodiment as viewed from the stacking direction.

FIG. 13 is a view illustrating a first half of a positive electrode intermediate sheet manufacturing step of an embodiment.

FIG. 14 is a view illustrating the latter half of the positive electrode intermediate sheet manufacturing step of an embodiment.

FIG. 15 is an enlarged view in which a positive electrode metal sheet in a punching step is enlarged.

FIG. 16 is a view illustrating a negative electrode intermediate sheet manufacturing step of an embodiment.

FIG. 17 is a view illustrating a separator intermediate sheet manufacturing step of an embodiment.

FIG. 18 is a view illustrating a stacking step and a segmentation step of an embodiment.

### DETAILED DESCRIPTION

Hereinafter, the present disclosure will be described in further detail including with reference to the drawings according to an embodiment. The present disclosure is not limited thereto. Further, constituent elements disclosed in an embodiment below can be suitably combined with each other.

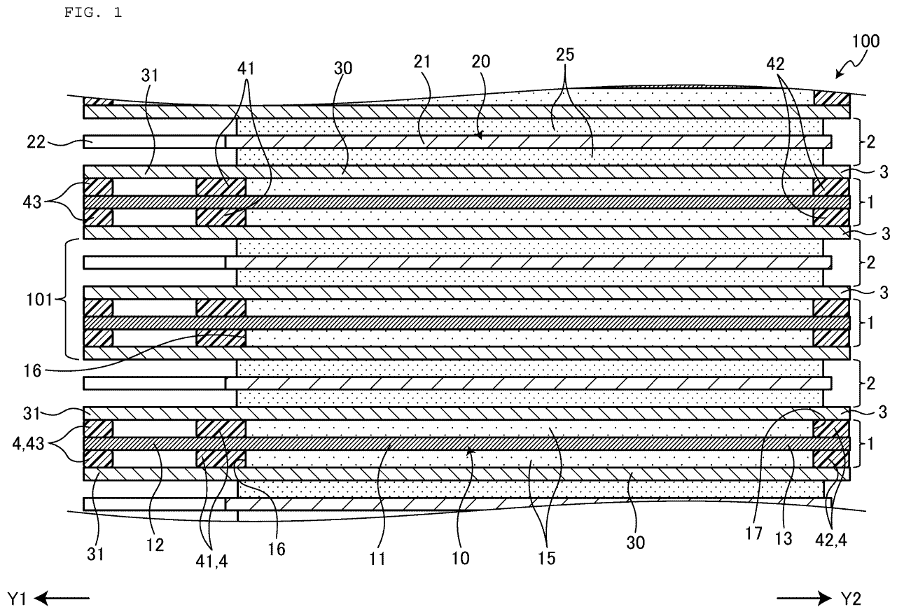

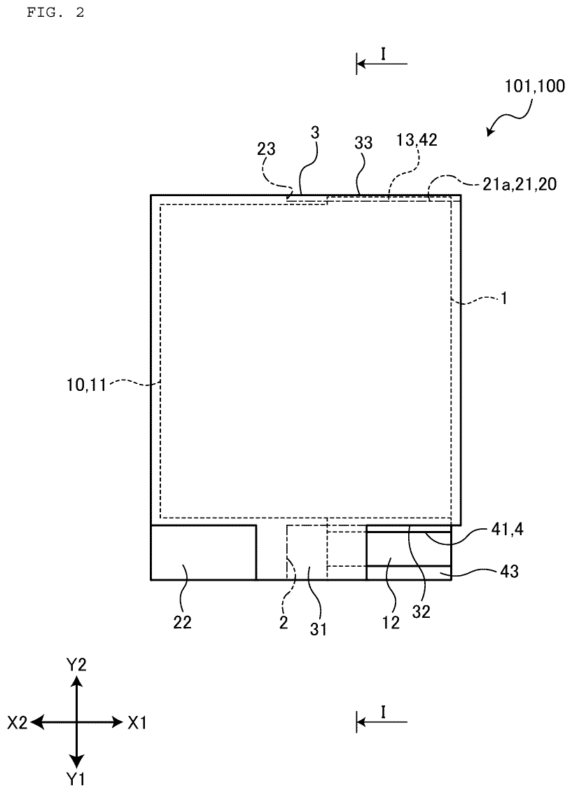

FIG. 1 is a sectional view of a stacked electrode assembly of a secondary battery according to a first embodiment, and is specifically a sectional view taken along line I-I in FIG. 2. As illustrated in FIG. 1, a lithium secondary battery according to the first embodiment includes a stacked electrode assembly 100. The stacked electrode assembly 100 is an electrode assembly in which a plurality of positive electrodes 1 and a plurality of negative electrodes 2 are alternately stacked with a separator 3 interposed therebetween. In other words, the stacked electrode assembly 100 is manufactured by stacking at least one stack 101 in which the separator 3, the positive electrode 1, the separator 3, and the negative electrode 2 are stacked in this order. Such a stacked electrode assembly 100 is sealed in an exterior body together with an electrolyte to constitute a lithium secondary battery. Hereinafter, a direction in which the positive electrode 1, the negative electrode 2, the separator 3, and the like are stacked is referred to as a stacking direction.

The positive electrode 1 includes a positive electrode metal current collector 10 and a positive electrode active material layer 15. The negative electrode 2 includes a negative electrode metal current collector 20 and a negative electrode active material layer 25. The positive electrode active material layer 15 is provided on both surfaces in the stacking direction of the positive electrode metal current collector 10. Similarly, the negative electrode active material layers 25 are provided on both surfaces in the stacking direction of the negative electrode metal current collector 20. The positive electrode active material layer 15 and the negative electrode active material layer 25 face each other in the stacking direction, and transfer lithium ions through the electrolyte. Note that, in the present disclosure, the positive electrode active material layer 15 and the negative electrode active material layer 25 may be provided only on one surface of the positive electrode metal current collector 10 or the negative electrode metal current collector 20.

The positive electrode metal current collector 10 and the negative electrode metal current collector 20 collect and supply electrons generated in the positive electrode active material layer 15 and the negative electrode active material layer 25 due to a battery reaction. The positive electrode metal current collector 10 and the negative electrode metal current collector 20 have a sheet shape. Note that the positive electrode metal current collector 10 and the negative electrode metal current collector 20 may be porous sheets. The positive electrode active material layer 15 is not stacked on a part of the positive electrode metal current collector 10, and constitutes a positive electrode metal current collector exposed portion 12. Similarly, the negative electrode active material layer 25 is not stacked on a part of the negative electrode metal current collector 20, and constitutes a negative electrode metal current collector exposed portion 22.

FIG. 2 is a view of the stack of the first embodiment as viewed from the stacking direction. As illustrated in FIG. 2, the positive electrode metal current collector exposed portion 12 and the negative electrode metal current collector exposed portion 22 are disposed so as to be shifted in a planar direction orthogonal to the stacking direction when viewed from the stacking direction. The positive electrode metal current collector exposed portion 12 faces the positive electrode metal current collector exposed portion 12 of the other positive electrode 1 in the stacking direction. The plurality of positive electrode metal current collector exposed portions 12 is connected to a positive electrode tab (not illustrated). Similarly, the negative electrode metal current collector exposed portion 22 faces the negative electrode metal current collector exposed portion 22 of the other negative electrode 2 in the stacking direction. The plurality of negative electrode metal current collector exposed portions 22 is connected to a negative electrode tab (not illustrated) by welding.

Hereinafter, in the planar direction, a direction in which the positive electrode metal current collector exposed portion 12 and the negative electrode metal current collector exposed portion 22 are disposed is referred to as a length direction. In the length direction, the direction in which the positive electrode metal current collector exposed portion 12 is disposed as viewed from the negative electrode metal current collector exposed portion 22 is referred to as a first length direction X1, and the opposite direction is referred to as a second length direction X2.

The separator 3 is a member for preventing a short circuit due to contact between the positive electrode 1 and the negative electrode 2 and holding the electrolyte. The separator 3 is a porous insulating member. Next, details of each configuration will be described.

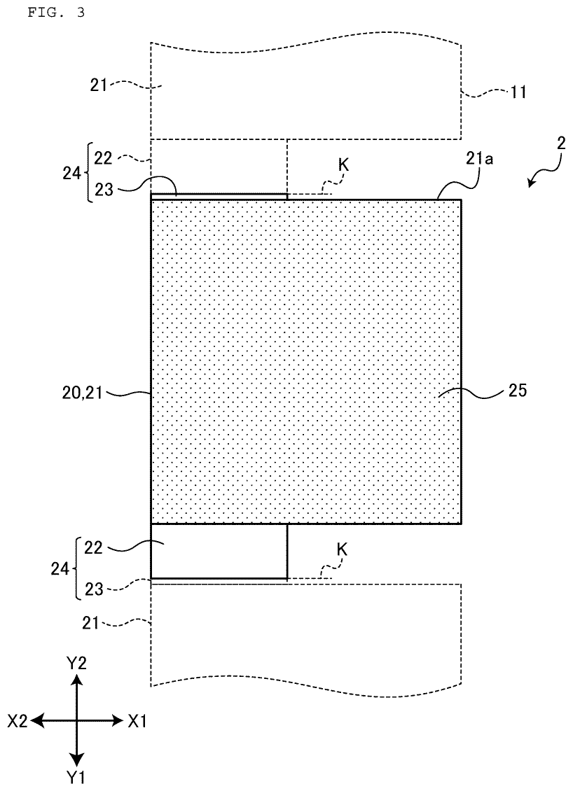

FIG. 3 is a view of the negative electrode of the first embodiment as viewed from the stacking direction. The negative electrode metal current collector 20 includes a rectangular negative electrode metal current collector body 21 on which the negative electrode active material layer 25 is stacked, a negative electrode metal current collector exposed portion 22 protruding from the negative electrode metal current collector body 21, and a negative electrode uncut portion 23 protruding from the negative electrode metal current collector body 21 in a direction opposite to the negative electrode metal current collector exposed portion 22. The negative electrode metal current collector exposed portion 22 is formed in a quadrangular shape when viewed from the stacking direction. The size of the negative electrode metal current collector exposed portion 22 in the length direction is less than half of the negative electrode metal current collector body 21.

Hereinafter, a direction in which the negative electrode metal current collector exposed portion 22, the negative electrode metal current collector body 21, and the negative electrode uncut portion 23 are disposed is referred to as a width direction. Further, the direction in which the negative electrode metal current collector exposed portion 22 is disposed as viewed from the negative electrode metal current collector body 21 is referred to as a first width direction Y1, and the opposite direction is referred to as a second width direction Y2.

In the negative electrode metal current collector 20 (negative electrode 2) of the present embodiment, a plurality of negative electrode metal current collectors 20 (negative electrode 2) is manufactured by cutting one sheet. Specifically, each of the negative electrode metal current collectors 20 is manufactured by processing a plurality of negative electrode metal current collectors 20 (see broken lines in FIG. 3) in a state of being connected in the width direction, and then cutting the negative electrode metal current collectors 20 so as to be divided in the width direction. That is, before being divided (cut), the negative electrode metal current collector body 21 is connected to the other negative electrode metal current collector body 21 by a connecting portion 24 protruding in the width direction from the negative electrode metal current collector body 21. Further, a plurality of negative electrode metal current collectors 20 is manufactured by cutting the connecting portion 24.

Here, when the cutting of the connecting portion 24 is performed along an edge portion 21a of the negative electrode metal current collector body 21 in the second width direction Y2, accuracy is required, and productivity cannot be improved. Thus, a position slightly shifted in the second width direction Y2 from the edge portion 21a of the negative electrode metal current collector body 21 (see the imaginary line K in FIG. 3) is cut. Accordingly, the connecting portion 24 is divided into two in the width direction. One of the connecting portions 24 becomes the negative electrode metal current collector exposed portion 22, and the other becomes the negative electrode uncut portion 23 of the other negative electrode metal current collector 20.

From the above, the negative electrode uncut portion 23 is a portion remaining when the negative electrode metal current collector 20 is manufactured. Thus, the negative electrode uncut portion 23 has the same size in the length direction as the negative electrode metal current collector exposed portion 22. Similarly to the negative electrode metal current collector exposed portion 22, the negative electrode uncut portion 23 is disposed close to an end in the second length direction X2 with respect to the edge portion 21b of the negative electrode metal current collector body. However, the negative electrode uncut portion 23 is smaller in size in the width direction than the negative electrode metal current collector exposed portion 22.

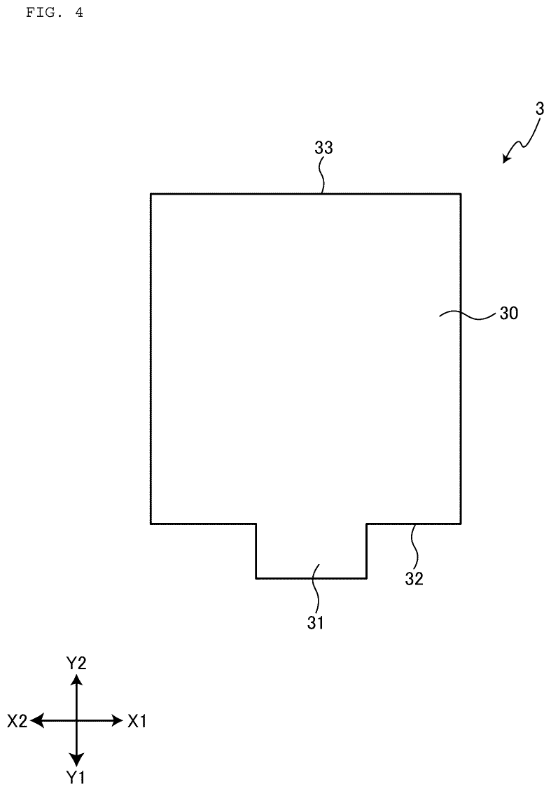

FIG. 4 is a view of the separator of the first embodiment as viewed from the stacking direction. The separator 3 has a quadrangular separator body 30 interposed between the positive electrode 1 and the negative electrode 2, and a protruding piece 31 protruding from the separator body 30 in the first width direction Y1. The protruding piece 31 is disposed at a central portion in the length direction of the separator body 30 to avoid contact between the positive electrode metal current collector exposed portion 12 and the negative electrode metal current collector exposed portion 22 (see FIG. 2).

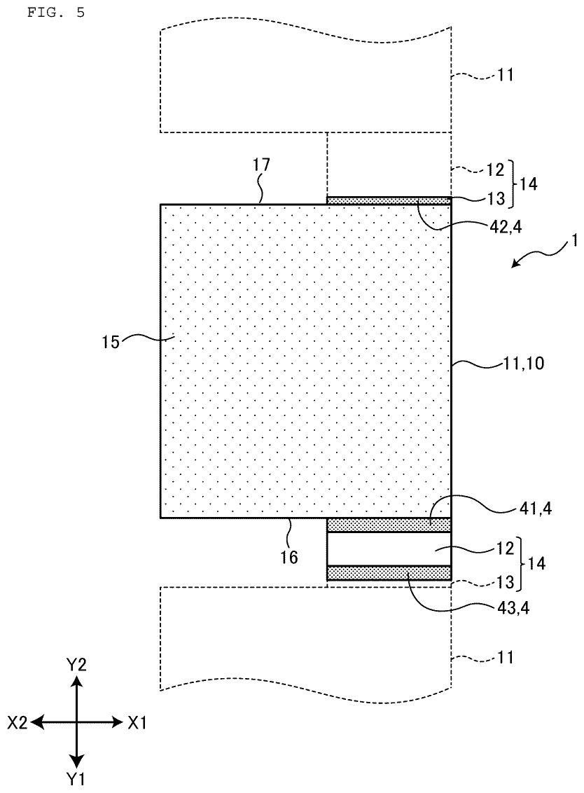

FIG. 5 is a view of the positive electrode of the first embodiment as viewed from the stacking direction. The positive electrode metal current collector 10 of the positive electrode 1 has a quadrangular positive electrode metal current collector body 11, a positive electrode metal current collector exposed portion 12 protruding from the positive electrode metal current collector body 11 in the first width direction Y1, and a positive electrode uncut portion 13 protruding from the positive electrode metal current collector body 11 in a direction opposite to the positive electrode metal current collector exposed portion 12.

The size of the positive electrode metal current collector body 11 in the length direction and the width direction is smaller than that of the separator body 30 (see FIG. 2). Accordingly, when the positive electrode metal current collector 10 is slightly displaced, the positive electrode metal current collector does not protrude outward from the separator body 30. A positive electrode active material layer 15 is stacked on the positive electrode metal current collector body 11. The positive electrode active material layer 15 has a quadrangular shape when viewed from the stacking direction, and is the same as the positive electrode metal current collector body 11. The edge portion of the positive electrode active material layer 15 has a first edge portion 16 disposed in the first width direction Y1 and a second edge portion 17 disposed on a side opposite to the first edge portion 16. Here, with respect to the position of the second edge portion 17, the side opposite to the first edge portion 16 means that the second edge portion 17 is disposed on the side opposite to the first edge portion 16 with respect to the center (the center in the length direction and the width direction) of the positive electrode active material layer 15. That is, the second edge portion 17 is an edge portion disposed in the second width direction Y2 of the positive electrode active material layer 15.

The positive electrode metal current collector exposed portion 12 is formed in a quadrangular shape in plan view. The length of the positive electrode metal current collector exposed portion 12 in the length direction is less than half of the positive electrode metal current collector body 11.

Similarly to the negative electrode uncut portion 23, the positive electrode uncut portion 13 is a portion remaining when a plurality of positive electrode metal current collectors 10 is manufactured from one sheet. That is, each of the positive electrode metal current collectors 10 is manufactured by processing a plurality of positive electrode metal current collectors 10 (see broken lines in FIG. 5) in a state of being connected in the width direction, and then cutting the positive electrode metal current collectors 10 so as to be divided in the width direction. Thus, before being divided (cut), the positive electrode metal current collector body 11 is connected to the other positive electrode metal current collector body 11 by a connecting portion 14 protruding in the width direction from the positive electrode metal current collector body 11. Further, a plurality of positive electrode metal current collectors 10 is manufactured by cutting the connecting portion 14. Furthermore, the portion where the connecting portion 14 is cut is thus cut at a position slightly shifted in the second width direction Y2 from the edge portion of the positive electrode metal current collector body 11 in the second width direction Y2. Accordingly, the connecting portion 14 is divided into two in the width direction. One of the connecting portions 14 becomes the positive electrode metal current collector exposed portion 12, and the other becomes the positive electrode uncut portion 13 of the other positive electrode metal current collector 10.

From the above, the size of the positive electrode uncut portion 13 in the length direction is the same as that of the positive electrode metal current collector exposed portion 12. Similarly to the positive electrode metal current collector exposed portion 12, the positive electrode uncut portion 13 is disposed close to an end in the first length direction X1 with respect to the edge portion 11b of the positive electrode uncut portion 13. However, the size of the positive electrode uncut portion 13 in the width direction is smaller than that of the positive electrode metal current collector exposed portion 12.

Further, the positive electrode 1 of the present embodiment has the adhesive layer 4. The adhesive layer 4 includes a first adhesive layer 41, a second adhesive layer 42, and a third adhesive layer 43.

The first adhesive layer 41 is stacked on an end of the positive electrode metal current collector exposed portion 12 in the second width direction Y2. Thus, the first adhesive layer 41 is adjacent to the first edge portion 16 of the positive electrode active material layer 15. Further, the first adhesive layer 41 extends in the length direction along the first edge portion 16.

The second adhesive layer 42 is stacked on the entire surface of the positive electrode uncut portion 13. Thus, the second adhesive layer 42 is adjacent to the second edge portion 17 of the positive electrode active material layer 15. The second adhesive layer 42 extends in the length direction along the second edge portion 17.

The third adhesive layer 43 is disposed on an edge portion of the positive electrode metal current collector exposed portion 12 in the first width direction Y1. Thus, the third adhesive layer 43 is separated from the first adhesive layer 41 in the width direction. Further, the third adhesive layer 43 extends in the length direction along the edge portion of the positive electrode metal current collector exposed portion 12 in the first width direction Y1.

In addition, the second adhesive layer 42 and the third adhesive layer 43 are stacked before being divided (before the connecting portion 14 is cut). In other words, a cutting adhesive layer (not illustrated) is applied to a portion to be cut which is an end of the connecting portion 14 in the first width direction Y1, and the cutting adhesive layer is cut in the length direction to be divided into the second adhesive layer 42 and the third adhesive layer 43. That is, according to the present embodiment, it is not necessary to separately provide the second adhesive layer 42 and the third adhesive layer 43.

As illustrated in FIG. 2, the first adhesive layer 41 adheres to the edge portion 32 of the separator body 30 in the first width direction Y1 and the protruding piece 31. The second adhesive layer 42 adheres to the edge portion 33 of the separator body 30 in the second width direction Y2. The third adhesive layer 43 adheres to the end of the protruding piece 31 in the first width direction Y1. Thus, the positive electrode 1 is bonded on both sides in the first width direction Y1 and the second width direction Y2 when viewed from the positive electrode active material layer 15, and positional deviation from the separator 3 is suppressed. That is, the positional deviation between the separator 3 and the positive electrode 1 is suppressed in a portion opposite to the positive electrode metal current collector exposed portion 12.

Although the first embodiment has been described above, the present disclosure is not limited to the example illustrated in the first embodiment. Hereinafter, other embodiments will be described. Note that other embodiments will be described focusing on modifications from the first embodiment.

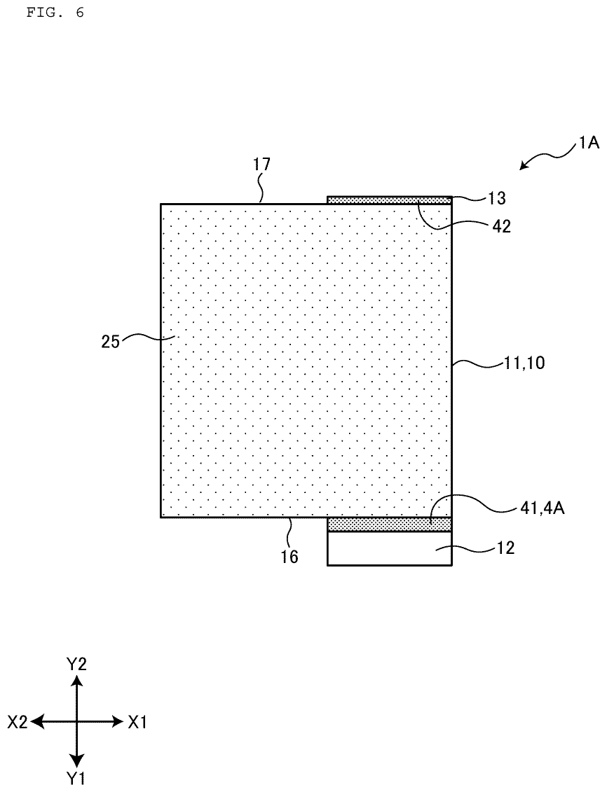

FIG. 6 is a view of a positive electrode of a second embodiment as viewed from the stacking direction. As illustrated in FIG. 6, in the second embodiment, the adhesive layer 4A of the positive electrode 1A is different from the adhesive layer of the first embodiment in not including the third adhesive layer 43. In such a second embodiment, the positive electrode 1A has the first adhesive layer 41 and the second adhesive layer 42. Thus, the positive electrode 1A is bonded on both sides in the first width direction Y1 and the second width direction Y2 when viewed from the positive electrode active material layer 15, and positional deviation from the separator 3 is suppressed.

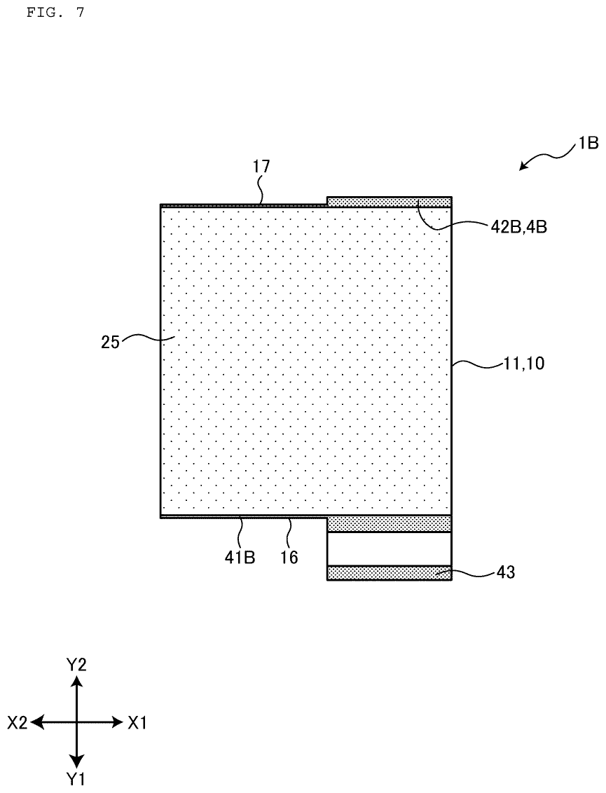

FIG. 7 is a view of the positive electrode of the third embodiment as viewed from the stacking direction. As illustrated in FIG. 7, in the third embodiment, an adhesive layer 4B of the positive electrode 1B is provided. The adhesive layer 4B includes a first adhesive layer 41B, a second adhesive layer 42B, and a third adhesive layer 43. The first adhesive layer 41B is different from the first adhesive layer 41 of the first embodiment in that a part of the first adhesive layer 41B is stacked on the first edge portion 16 of the positive electrode active material layer 15. A portion of the first adhesive layer 41B stacked on the first edge portion 16 extends in the length direction along the first edge portion 16 and is stacked on the entire first edge portion 16.

Further, the second adhesive layer 42B is different from the second adhesive layer 42 of the first embodiment in that a part of the second adhesive layer 42B is stacked on the second edge portion 17 of the positive electrode active material layer 15. In addition, a portion of the second adhesive layer 42B stacked on the second edge portion 17 extends in the length direction along the second edge portion 17 and is stacked on the entire second edge portion 17. According to the third embodiment, the bonding area with the separator 3 is increased, and the bonding strength with the separator 3 is strengthened. Thus, positional deviation between the separator 3 and the positive electrode 1 is reliably suppressed.

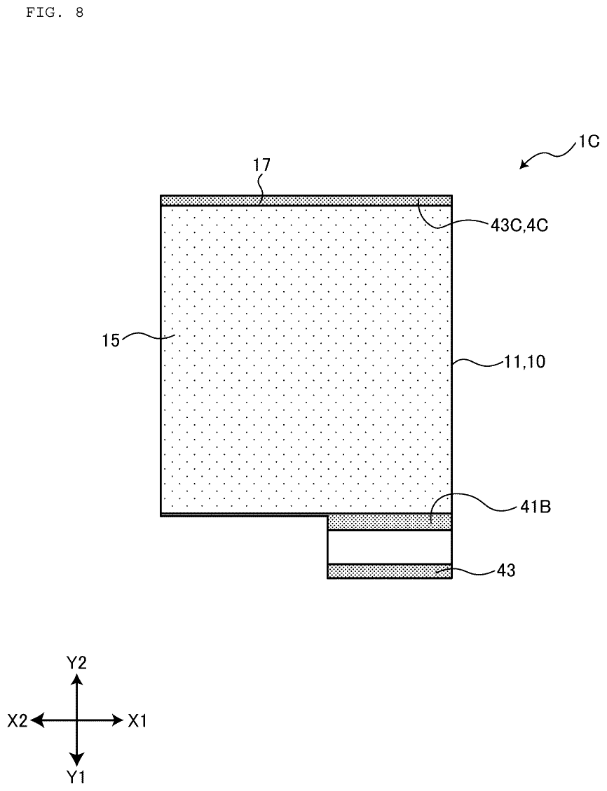

FIG. 8 is a view of a positive electrode of a fourth embodiment as viewed from the stacking direction. As illustrated in FIG. 8, in the fourth embodiment, a positive electrode metal current collector 10C of a positive electrode 1C is different from the first embodiment in that there is no positive electrode uncut portion 13. Further, the adhesive layer 4C of the fourth embodiment includes a first adhesive layer 41B, a second adhesive layer 42C, and a third adhesive layer 43. The second adhesive layer 42C is different from the second adhesive layer 42 of the first embodiment in that the second adhesive layer is stacked on the second edge portion 17 of the positive electrode active material layer 15.

In such a second adhesive layer 42C illustrated in the fourth embodiment, the positional deviation between the separator 3 and the positive electrode 1 is suppressed in the portion on the opposite side to the positive electrode metal current collector exposed portion 12.

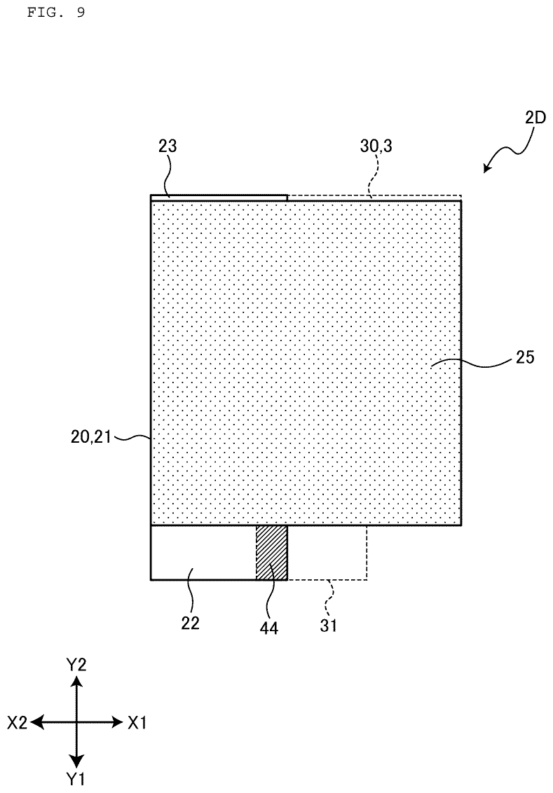

FIG. 9 is a view of a negative electrode of a fifth embodiment as viewed from the stacking direction. As illustrated in FIG. 9, a negative electrode 2D of the fifth embodiment is different from the first embodiment in that it has a fourth adhesive layer 44. The fourth adhesive layer 44 is stacked on an end of the negative electrode metal current collector exposed portion 22 in the first length direction X1. The fourth adhesive layer 44 adheres to the end of the protruding piece 31 in the second length direction X2. According to the fifth embodiment, positional deviation between the negative electrode 2D and the separator 3 is suppressed, and a state in which the positive electrode active material layer 15 and the negative electrode active material layer 25 face each other is maintained.

Next, an example in which the shapes of the positive electrode 1, the negative electrode 2, and the separator 3 are changed will be described.

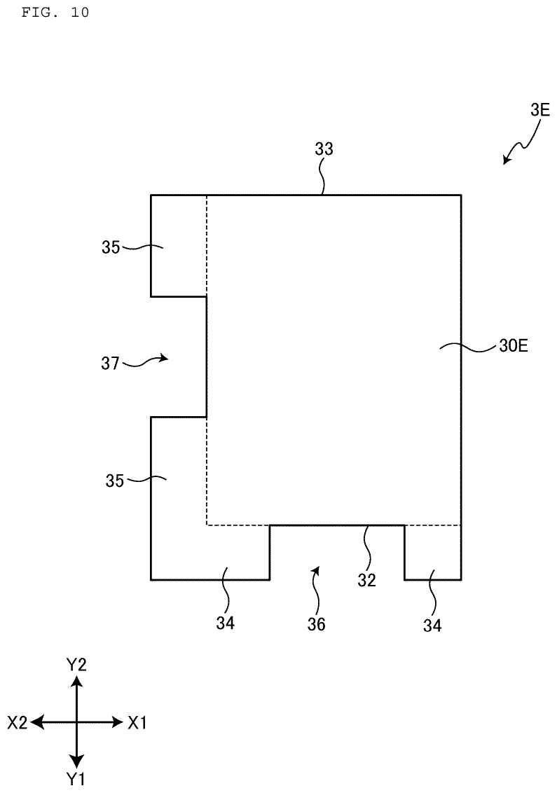

FIG. 10 is a view of the separator of a sixth embodiment as viewed from the stacking direction. A separator 3E of the sixth embodiment has a quadrangular separator body 30E, a pair of first protrusions 34 and 34 protruding from an edge portion 32 of the separator body 30E in the first width direction Y1, and a pair of second protrusions 35 and 35 protruding from an edge portion of the separator body 30E in the second length direction X2. The pair of first protrusions 34 is separated from each other in the length direction. A first opening 36 penetrating in the stacking direction is provided between the pair of first protrusions 34 and 34. The pair of second protrusions 35 and 35 is separated from each other in the width direction. A second opening 37 penetrating in the stacking direction is provided between the pair of second protrusions 35 and 35.

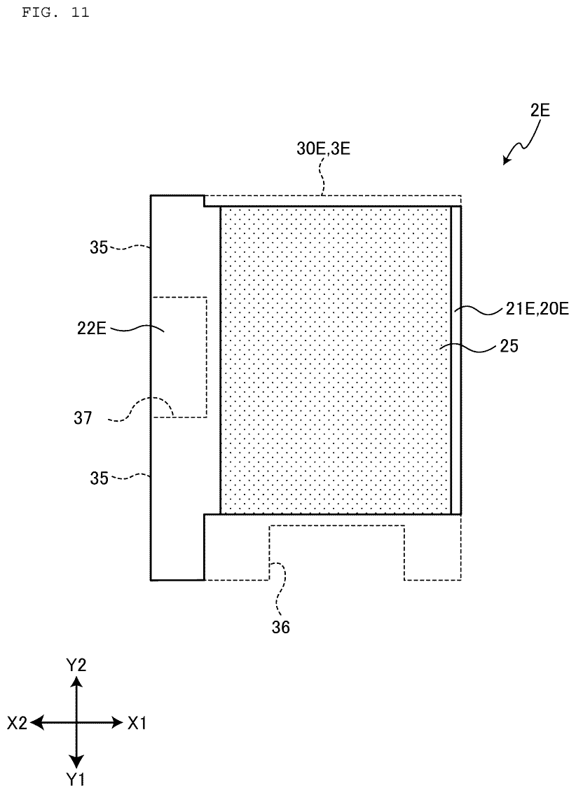

FIG. 11 is a view of the negative electrode of the sixth embodiment as viewed from the stacking direction. As illustrated in FIG. 11, a negative electrode metal current collector 20E of a negative electrode 2E has a quadrangular negative electrode metal current collector body 21E on which the negative electrode active material layer 25 is stacked, and a negative electrode metal current collector exposed portion 22E protruding from the negative electrode metal current collector body 21E in the second length direction X2. The negative electrode metal current collector body 21 and the negative electrode active material layer 25 are stacked so as to overlap with the separator body 30E. That is, the negative electrode metal current collector body 21 and the negative electrode active material layer 25 are not exposed from the first opening 36. Further, the negative electrode metal current collector exposed portion 22E is stacked so as to overlap the pair of second protrusions 35 and 35. Then, the central portion in the width direction of the negative electrode metal current collector exposed portion 22E is exposed from the second opening 37 and faces the negative electrode metal current collector exposed portion 22E of another negative electrode 2E disposed in the stacking direction.

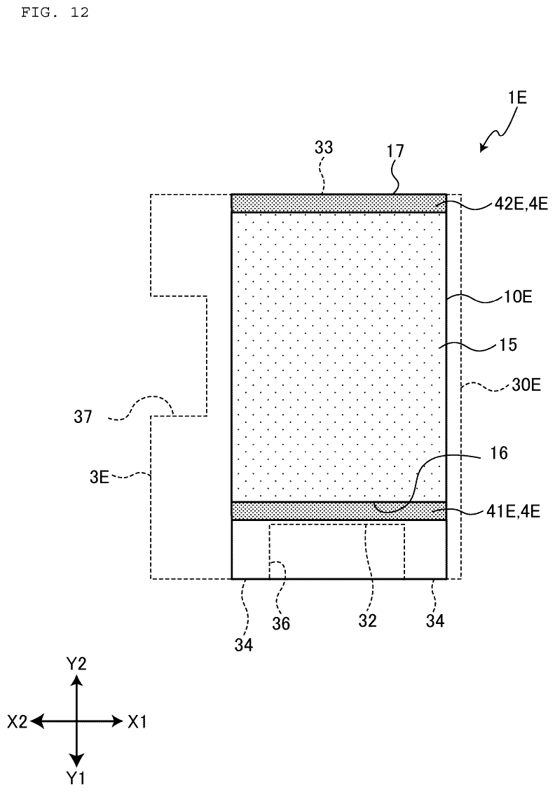

FIG. 12 is a view of the positive electrode of the sixth embodiment as viewed from the stacking direction. As illustrated in FIG. 12, the positive electrode metal current collector 10E of the positive electrode 1E includes a positive electrode metal current collector body 11E on which the positive electrode active material layer 15 is stacked, and a positive electrode metal current collector exposed portion 12E protruding from the positive electrode metal current collector body 11E in the first width direction Y1. The positive electrode metal current collector body 11E and the positive electrode active material layer 15 are stacked so as to overlap with the separator body 30E. Thus, the positive electrode metal current collector body 11E and the positive electrode active material layer 15 are not exposed from the second opening 37. The positive electrode metal current collector exposed portion 12E is stacked so as to overlap the first protrusions 34 and 34. The central portion in the length direction of the positive electrode metal current collector exposed portion 12E is exposed in the stacking direction from the first opening 36 and faces the positive electrode metal current collector exposed portion 12E of another positive electrode 1E arranged in the stacking direction.

The adhesive layer 4E provided on the positive electrode 1E includes a first adhesive layer 41E and a second adhesive layer 42E. The first adhesive layer 41E is stacked on the positive electrode metal current collector exposed portion 12E and extends along the first edge portion 16 of the positive electrode active material layer 15. The second adhesive layer 42E is stacked on the second edge portion 17 of the positive electrode active material layer 15 and extends along the second edge portion 17. The first adhesive layer 41E adheres to the edge portion 32 of the separator body 30E in the first width direction Y1. The second adhesive layer 42E adheres to the edge portion 33 of the separator body 30E in the second width direction Y2. As described above, the positive electrode 1E is bonded on both sides in the first width direction Y1 and the second width direction Y2 when viewed from the positive electrode active material layer 15, and positional deviation from the separator 3E is suppressed.

Note that the present disclosure may also be applied to a positive electrode, a negative electrode, and a separator other than the shapes illustrated in the first to sixth embodiments. In each embodiment, an example is described in which the positive electrode active material layer 15 and the negative electrode active material layer 25 are stacked on the positive electrode metal current collector 10 and the negative electrode metal current collector 20, but the present disclosure may be stacked on the separator 3, and is not particularly limited.

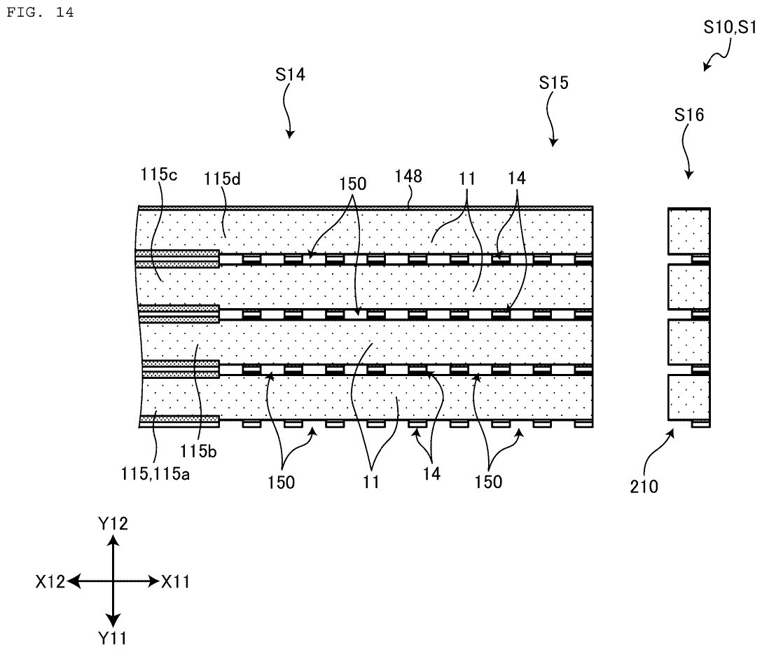

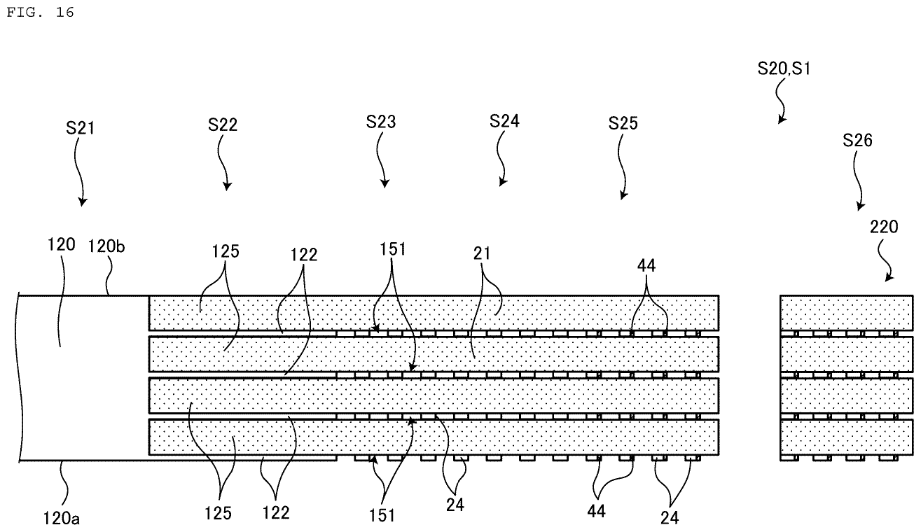

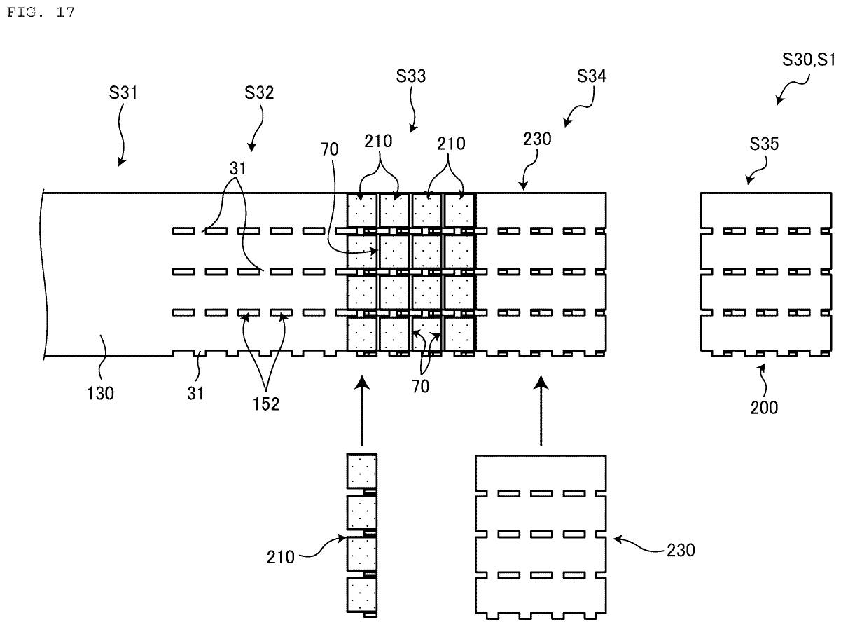

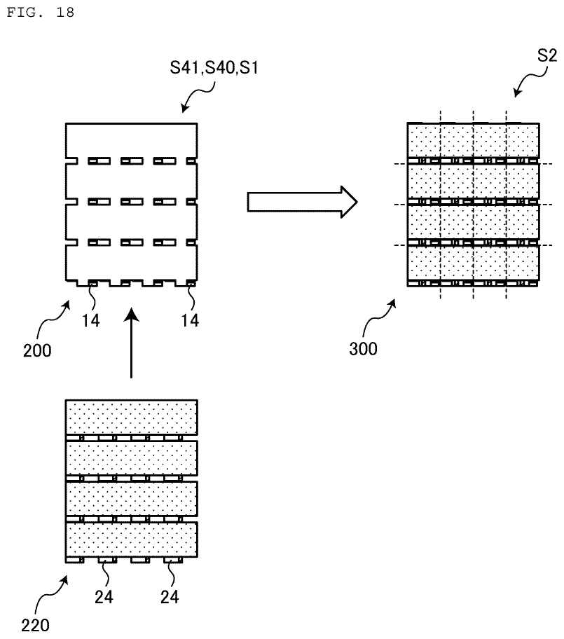

In a seventh embodiment, a method for manufacturing the stacked electrode assembly 100 in the secondary battery will be described. Note that, in the present embodiment, an example of manufacturing the stack 101 which is a part of the stacked electrode assembly 100 will be described. A method for manufacturing the stacked electrode assembly 100 (stack 101) includes an intermediate stack manufacturing step S1 of manufacturing the intermediate stack 300 (see FIG. 18) and a segmentation step S2 of segmenting the intermediate stack 300 to manufacture the stack 101 (stacked electrode assembly 100). The intermediate stack 300 is formed by alternately stacking the positive electrode intermediate sheet 210 and the negative electrode intermediate sheet 220 with the separator intermediate sheet 230 interposed therebetween. Further, the positive electrode intermediate sheet 210 has a sheet shape in which a plurality of positive electrodes 1 is assembled (see FIG. 14). The negative electrode intermediate sheet 220 has a sheet shape in which a plurality of negative electrodes 2 is assembled (see FIG. 16). The separator intermediate sheet 230 has a sheet shape in which a plurality of separators 3 is assembled (see FIG. 17).

The intermediate stack manufacturing step S1 includes a positive electrode intermediate sheet manufacturing step S10 of manufacturing the positive electrode intermediate sheet 210, a negative electrode intermediate sheet manufacturing step S20 of manufacturing the negative electrode intermediate sheet 220, a separator intermediate sheet manufacturing step S30 of manufacturing the separator intermediate sheet 230, and a stacking step S40 of stacking the positive electrode intermediate sheet 210, the negative electrode intermediate sheet 220, and the separator intermediate sheet 230. Each step will be described below.

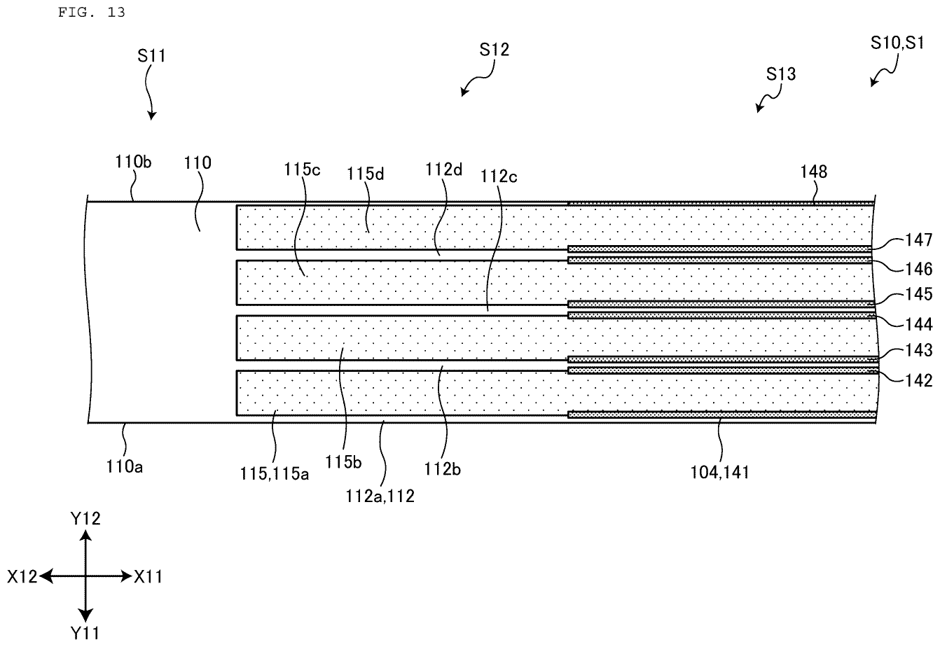

FIG. 13 is a view illustrating the first half of the positive electrode intermediate sheet manufacturing step of the seventh embodiment. FIG. 14 is a view illustrating the latter half of the positive electrode intermediate sheet manufacturing step of the seventh embodiment. As illustrated in FIGS. 13 and 14, the positive electrode intermediate sheet manufacturing step S10 includes a preparation step S11, a positive electrode active material layer forming step S12, an adhesive layer forming step S13, a punching step S14, a burr removing step S15, and a cutting step S16.

As illustrated in FIG. 13, the preparation step S11 is a step of preparing a positive electrode metal sheet 110 to be a material of the positive electrode metal current collector 10. The positive electrode metal sheet 110 has a band shape. Further, in the preparation step S11, one end of the positive electrode metal sheet 110 in the longitudinal direction is placed on a line (not illustrated). Then, the positive electrode metal sheet 110 is continuously conveyed on the line.

Hereinafter, the direction in which the line extends is referred to as a line direction. Further, in the line direction, the direction in which the positive electrode metal sheet 110 is conveyed is referred to as a traveling direction X11, and the opposite direction is referred to as a backward direction X12. In addition, a direction crossing the traveling direction X11 in plan view is referred to as a cross direction. One of cross directions is referred to as a first cross direction Y11, and the opposite is referred to as a second cross direction Y12. Further, the size of the positive electrode metal sheet 110 in the cross direction is such that four positive electrode metal current collectors 10 can be manufactured.

The positive electrode active material layer forming step S12 is a step of forming the positive electrode active material layer 15 on both surfaces or one surface of the positive electrode metal sheet 110. In the present embodiment, a positive electrode active material is applied to both surfaces of the positive electrode metal sheet 110, and the positive electrode active material is cured to form the positive electrode active material layer 15. Further, in the positive electrode active material layer forming step S12, the positive electrode active material is continuously applied to the positive electrode metal sheet 110. Thus, a long positive electrode active material layer 115 continuous in the line direction is formed on both surfaces or one surface of the positive electrode metal sheet 110.

In addition, in the present embodiment, the positive electrode active material is applied at four places at intervals in the cross direction. Thus, the four long positive electrode active material layers 115 arranged at equal intervals in the cross direction are formed on the positive electrode metal sheet 110. Hereinafter, the four long positive electrode active material layers 115 are referred to as a first long positive electrode active material layer 115a, a second long positive electrode active material layer 115b, a third long positive electrode active material layer 115c, and a fourth long positive electrode active material layer 115d in order from the first cross direction Y11.

Further, according to the positive electrode active material layer forming step S12, four non-applied regions 112 to which the positive electrode active material is not applied are formed. The non-applied regions 112 extend in the traveling direction X11 and are arranged at equal intervals in the cross direction. Hereinafter, the four non-applied regions 112 are referred to as a first non-applied region 112a, a second non-applied region 112b, a third non-applied region 112c, and a fourth non-applied region 112d in order from the first cross direction Y11.

The second non-applied region 112b, the third non-applied region 112c, and the fourth non-applied region 112d are provided between the four long positive electrode active material layers 115. The first long positive electrode active material layer 115a is separated from the end 110a of the positive electrode metal sheet 110 in the first cross direction Y11 in the second cross direction Y12. Thus, the first non-applied region 112a to which the positive electrode active material is not applied is provided along the end 110a of the positive electrode metal sheet 110. On the other hand, the fourth long positive electrode active material layer 115d extends along the end 110b of the positive electrode metal sheet 110 in the second cross direction Y12. Thus, the non-applied region 112 is not provided along the end 110b of the positive electrode metal sheet 110.

The adhesive layer forming step S13 is a step of forming the adhesive layer 4 (see FIG. 1) on both surfaces or one surface of the positive electrode metal sheet 110. In the present embodiment, an adhesive is applied to both surfaces or one surface of the positive electrode metal sheet 110. Further, an adhesive is continuously applied to the positive electrode metal sheet 110. Thus, the long adhesive layer 104 continuously extending in the line direction is formed on both surfaces or one surface of the positive electrode metal sheet 110. Note that, in the present embodiment, the long adhesive layer 104 is formed by application, but the present disclosure is not particularly limited, and screen printing may be performed or an adhesive may be atomized and sprayed.

Further, the adhesive is applied at eight places at intervals in the cross direction. Accordingly, eight long adhesive layers 104 are formed. Hereinafter, the eight long adhesive layers 104 are referred to as a first long adhesive layer 141, a second long adhesive layer 142, a third long adhesive layer 143, a fourth long adhesive layer 144, a fifth long adhesive layer 145, a sixth long adhesive layer 146, a seventh long adhesive layer 147, and an eighth long adhesive layer 148 in this order from the first cross direction Y11. Note that the eighth long adhesive layer 148 is thinner than the other long adhesive layers 104 (see FIGS. 13 to 15).

The first long adhesive layer 141 is stacked over an end of the first non-applied region 112a in the second cross direction Y12 and an edge portion of the first long positive electrode active material layer 115a in the first cross direction Y11. The second long adhesive layer 142 is stacked over an edge portion of the first long positive electrode active material layer 115a in the second cross direction Y12 and an end of the second non-applied region 112b in the first cross direction Y11.

The third long adhesive layer 143 is stacked over an end of the second non-applied region 112b in the second cross direction Y12 and an edge portion of the second long positive electrode active material layer 115b in the first cross direction Y11. The fourth long adhesive layer 144 is stacked over an edge portion of the second long positive electrode active material layer 115b in the second cross direction Y12 and an end of the third non-applied region 112c in the first cross direction Y11.

The fifth long adhesive layer 145 is stacked over an end of the third non-applied region 112c in the second cross direction Y12 and an edge portion of the third long positive electrode active material layer 115c in the first cross direction Y11. The sixth long adhesive layer 146 is stacked over an edge portion of the third long positive electrode active material layer 115c in the second cross direction Y12 and an end of the fourth non-applied region 112d in the first cross direction Y11.

The seventh long adhesive layer 147 is stacked over an end of the fourth non-applied region 112d in the second cross direction Y12 and an edge portion of the fourth long positive electrode active material layer 115d in the first cross direction Y11. The eighth long adhesive layer 148 is stacked along an edge portion of the fourth long positive electrode active material layer 115d in the second cross direction Y12.

As illustrated in FIG. 14, the punching step S14 is a step of pressing a punch (not illustrated) against the positive electrode metal sheet 110 to form the through hole 150. The through hole 150 has a quadrangular shape in plan view. The through hole 150 is formed in the non-applied region 112. The punch is intermittently pressed against the positive electrode metal sheet 110. Thus, a plurality of through holes 150 is formed in the non-applied region 112 at intervals in the line direction. The remaining portion of the non-applied region 112 serves as the connecting portion 14 (see FIG. 5) for connecting the positive electrode metal current collector body 11.

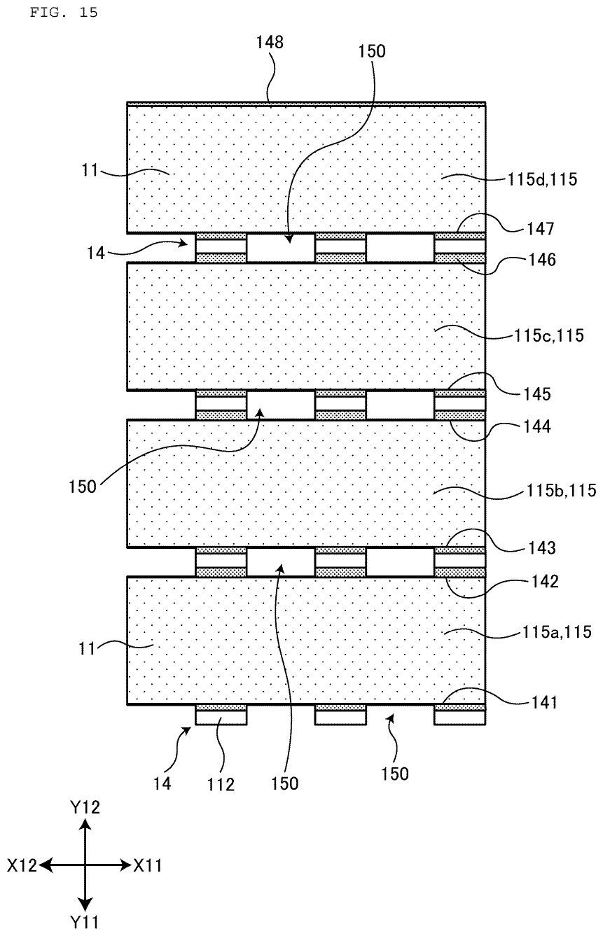

FIG. 15 is an enlarged view of the positive electrode metal sheet in the punching step. Describing details of the punching step S14, as illustrated in FIG. 15, the size of the punch (through hole 150) in the cross direction is the same as the size of the non-applied region 112 in the cross direction. Thus, the portion stacked on the non-applied region 112 is removed from the first long adhesive layer 141 to the seventh long adhesive layer 147. As a result, the first long adhesive layer 141 to the seventh long adhesive layer 147 are stacked only on the long positive electrode active material layer 115 in a range overlapping with the through hole 150 in the cross direction, and have a small width in the cross direction. Note that the eighth long adhesive layer 148 not stacked on the non-applied region 112 is not removed and remains as it is.

As illustrated in FIG. 14, the burr removing step S15 is a step of crushing the positive electrode metal sheet 110 with a roller (not illustrated) to remove a burr (not illustrated) formed at an edge portion of the through hole 150. The cutting step S16 is a step of cutting the positive electrode metal sheet 110 in the cross direction. In this manner, the positive electrode intermediate sheet 210 in which the four positive electrodes 1 are continuous in the cross direction is manufactured. Note that the positive electrode intermediate sheet 210 is cut so that the size thereof in the length direction is smaller than the size of the separator 3 (see FIG. 4) in the length direction.

FIG. 16 is a view illustrating a negative electrode intermediate sheet manufacturing step of the seventh embodiment. As illustrated in FIG. 16, the negative electrode intermediate sheet manufacturing step S20 includes a preparation step S21, a negative electrode active material layer forming step S22, a punching step S23, a burr removing step S24, an adhesive layer forming step S25, and a cutting step S26. Note that the contents overlapping with the positive electrode intermediate sheet manufacturing step S10 will be briefly described.

The preparation step S21 is a step of preparing the negative electrode metal sheet 120 to be a material of the negative electrode metal current collector 20. The negative electrode metal sheet 120 has a band shape. The size of the negative electrode metal sheet 120 in the cross direction is such that four negative electrode metal current collectors 20 can be manufactured. Then, the negative electrode metal sheet 120 is carried on the line.

The negative electrode active material layer forming step S22 is a step of forming the negative electrode active material layer 25 on both surfaces or one surface of the negative electrode metal sheet 120. In the present embodiment, the negative electrode active material is applied to both surfaces or one surface of the negative electrode metal sheet 120, and then the negative electrode active material is cured to form the negative electrode active material layer 25. Further, the negative electrode active material is continuously applied to the negative electrode metal sheet 120. In addition, the negative electrode active material is applied at four places at intervals in the cross direction. Thus, four long negative electrode active material layers 125 arranged at equal intervals in the cross direction are formed. Further, between the four long negative electrode active material layers 125, three non-applied regions 122 to which the negative electrode active material is not applied are formed.

Further, among the four long negative electrode active material layers 125, the long negative electrode active material layer 125 disposed closest to the first cross direction Y11 is separated from the end 120a of the negative electrode metal sheet 120 in the first cross direction Y11. Thus, a non-applied region 122 is generated at the end 120a of the negative electrode metal sheet 120 in the first cross direction Y11. Further, among the four long negative electrode active material layers 125, the long negative electrode active material layer 125 disposed closest to the second cross direction Y12 is stacked along the end 120b of the negative electrode metal sheet 120 in the second cross direction Y12. Thus, a non-applied region is not formed at the end 120b of the negative electrode metal sheet 120 in the second cross direction Y12.

The punching step S23 is a step of pressing a punch (not illustrated) against the negative electrode metal sheet 120 to form a through hole 151. The through hole 151 has a quadrangular shape. The through hole 151 is formed in the non-applied region 122. Further, the punch is intermittently pressed against the negative electrode metal sheet 120. Thus, a plurality of through holes 151 is formed at intervals in the line direction. Further, the remaining portion of the non-applied region 122 serves as a connecting portion 24 for connecting the negative electrode metal current collector body 21 (see FIG. 3).

The burr removing step S24 is a step of crushing the negative electrode metal sheet 120 with a roller to remove a burr (not illustrated) at an edge portion of the through hole 151. The adhesive layer forming step S25 is a step of forming the fourth adhesive layer 44 on the negative electrode metal sheet 120. In the present embodiment, the fourth adhesive layer 44 is formed by screen printing. Note that, in the present disclosure, formation of fourth adhesive layer 44 is not limited to screen printing. Further, the fourth adhesive layer 44 is formed on the end of the connecting portion 24 in the traveling direction X11.

The cutting step S26 is a step of cutting the negative electrode metal sheet 120 in the cross direction. In this manner, the negative electrode intermediate sheet 220 in which a total of 16 negative electrodes 2 of 4 rows in the cross direction and 4 rows in the line direction are connected is manufactured.

FIG. 17 is a view illustrating a separator intermediate sheet manufacturing step of the seventh embodiment. As illustrated in FIG. 17, the separator intermediate sheet manufacturing step S30 includes a preparation step S31, a punching step S32, a first stacking step S33, a second stacking step S34, and a cutting step S35.

The preparation step S31 is a step of preparing the separator sheet 130 to be a material of the separator intermediate sheet 230. Further, in the preparation step S31, the separator sheet 130 is conveyed on the line. Furthermore, the size of the separator sheet 130 in the cross direction is large enough to manufacture four separators 3.

The punching step S32 is a step of pressing a punch (not illustrated) against the separator sheet 130 to form a through hole 152 in the separator sheet 130. The through holes 152 are formed at intervals in the line direction. Thus, the protruding piece 31 is formed between the through hole 152 and the through hole 152 (see FIG. 4).

The first stacking step S33 is a step of stacking the positive electrode intermediate sheet 210 on the separator sheet 130. Through this step, the long adhesive layer 104 disposed on one surface of the positive electrode intermediate sheet 210 adheres to the separator sheet 130. Here, the size of the positive electrode intermediate sheet 210 in the line direction is smaller than that of the separator 3. Accordingly, a gap 70 is formed between the positive electrode intermediate sheets 210 adjacent to each other in the line direction. Thus, when the separator intermediate sheet 230 is cut so as to pass between the positive electrode intermediate sheets 210, the end of the positive electrode 1 in the line direction is disposed inside the end of the separator 3 in the line direction. Thus, contact with the negative electrode 2 is avoided.

The second stacking step S34 is a step of stacking the already produced separator intermediate sheet 230 on the positive electrode intermediate sheet 210. Thus, the long adhesive layer 104 disposed on the other surface of the positive electrode intermediate sheet 210 adheres to the separator intermediate sheet 230. In the separator intermediate sheet 230, a total of 16 separators 3 of 4 rows in the line direction and 4 rows in the cross direction are continuous. Further, in the second stacking step S34, after the separator intermediate sheet 230 is stacked, a compressive load is applied in the stacking direction to pressure-bond the separator sheet 130, the positive electrode intermediate sheet 210, and the separator intermediate sheet 230. Then, after the adhesive layer 4 is cured, the cutting step S35 is performed.

The cutting step S35 and a step of cutting the separator sheet 130. Here, the positive electrode intermediate sheets 210 arranged in four rows in the line direction are cut as one set. Thus, the adhesive body 200 in which the two separator intermediate sheets 230 and the positive electrode intermediate sheet 210 are adhered to each other is manufactured.

FIG. 18 is a view illustrating a stacking step and a segmentation step of the seventh embodiment. The stacking step S40 includes a third stacking step S41. Note that, in the present embodiment, the first stacking step S33 and the second stacking step S34 are included in the separator intermediate sheet manufacturing step S30, but may be performed in the stacking step S40. That is, in the separator intermediate sheet manufacturing step S30, the cutting step S35 is performed without performing the first stacking step S33 and the second stacking step S34 to manufacture the separator intermediate sheet 230. Thereafter, the first stacking step S33 and the second stacking step S34 may be performed in the stacking step S40 to manufacture the adhesive body 200.

The third stacking step S41 is a step of stacking the negative electrode intermediate sheet 220 on the adhesive body 200. In this manner, the intermediate stack 300 in which the separator intermediate sheet 230, the positive electrode intermediate sheet 210, the separator intermediate sheet 230, and the negative electrode intermediate sheet 220 are stacked in this order is manufactured.

The segmentation step S2 is a step of cutting the intermediate stack 300 to manufacture the stack 101. In the present embodiment, cutting is performed at three positions while changing the position in each of the line direction and the cross direction (see broken lines in FIG. 18). Thus, 16 stacks 101 are manufactured.

In addition, when the intermediate stack 300 is cut in the cross direction, the intermediate stack is cut along the gap 70 (see FIG. 17) between the positive electrode intermediate sheets 210. On the other hand, when the intermediate stack 300 is cut in the line direction, as illustrated in FIGS. 3 and 5, the connecting portions 14 and 24 at positions slightly separated from the second edge portion 17 are cut. Thus, the positive electrode metal current collector 10 of the positive electrode 1 has the positive electrode uncut portion 13. Further, the negative electrode metal current collector 20 of the negative electrode 2 has a negative electrode uncut portion 23.

More specifically, when the connecting portions 14 and 24 are cut, the connection parts are cut so as to overlap the second long adhesive layer 142, the fourth long adhesive layer 144, and the sixth long adhesive layer 146 (see FIG. 15). In this manner, a part of the second long adhesive layer 142, the fourth long adhesive layer 144, and the sixth long adhesive layer 146 becomes the second adhesive layer 42, and the rest becomes the third adhesive layer 43. Thus, the effort of applying each of the second adhesive layer 42 and the third adhesive layer 43 to the positive electrode 1 is saved. Thus, since the second long adhesive layer 142, the fourth long adhesive layer 144, and the sixth long adhesive layer 146 are cut in the segmentation step s2, they may be referred to as cutting adhesive layers.

According to the above manufacturing process, in the intermediate stack 300, the positive electrode 1 of the stack 101 of the second row and the third row in the cross direction has the first adhesive layer 41, the second adhesive layer 42, and the third adhesive layer 43. The first adhesive layer 41 extends along the positive electrode metal current collector exposed portion 12 and the first edge portion 16 of the positive electrode active material layer 15 (see FIG. 7). The second adhesive layer 42 extends along the positive electrode uncut portion 13 and the second edge portion 17 of the positive electrode active material layer 15 (see FIG. 7). The third adhesive layer 43 extends along an end of the positive electrode metal current collector exposed portion 12 in the first width direction Y1.

Further, the first long adhesive layer 141 is stacked over the first non-applied region 112a and the first long positive electrode active material layer 115a, and is not stacked on an end of the first non-applied region 112a in the first cross direction Y11. Thus, in the intermediate stack 300, the positive electrode 1 of the stack 101 of the first row in the cross direction has the first adhesive layer 41 and the second adhesive layer 42, but does not have the third adhesive layer 43.

Further, the eighth long adhesive layer 148 is stacked along an edge portion of the fourth long positive electrode active material layer 115d in the second cross direction Y12. Thus, in the intermediate stack 300, the positive electrode 1 of the stack 101 of the fourth row in the cross direction has the first adhesive layer 41, the second adhesive layer 42, and the third adhesive layer 43. Further, the second adhesive layer 42 does not have the positive electrode uncut portion 13, and extends along the second edge portion 17 of the positive electrode active material layer 15.

From the above, in each stack 101, the positive electrode 1 has the second adhesive layer 42, and the positional deviation between the end of the positive electrode metal current collector 10 in the second cross direction Y12 and the separator 3 is suppressed. Further, since the negative electrode metal current collector 20 of the negative electrode 2 has the fourth adhesive layer 44, positional deviation from the separator 3 is suppressed. Note that, in the segmentation step S2 of the seventh embodiment, one intermediate stack 300 is cut, but the intermediate stack 300 may be stacked to form the stacked electrode assembly 100 and then segmented. In addition, when the stacked electrode assembly 100 is configured and then segmented, the positive electrode tab or the negative electrode tab may be connected to the intermediate stack 300 by welding before the segmentation step S2. In the seventh embodiment, the adhesive layer forming step S13 is performed after the positive electrode active material layer forming step S12, but the adhesive layer forming step S13 may be performed after the punching step S14 and the burr removing step S15. That is, the order of the adhesive layer forming step S13 is not particularly limited.

### Examples

Next, an example will be described according to an embodiment. As an example, a secondary battery was manufactured and tested. The stacked electrode assembly 100 used in the secondary battery is a stack 101 manufactured by the manufacturing method of the seventh embodiment. Specifically, stacks 101 disposed in the second and third rows in the cross direction among the intermediate stacks 300 were used in the test. That is, the positive electrode metal current collector 10 has the positive electrode uncut portion 13. The adhesive layer 4 includes a first adhesive layer 41, a second adhesive layer 42, and a third adhesive layer 43. The first adhesive layer 41 extends along the positive electrode metal current collector exposed portion 12 and the first edge portion 16 of the positive electrode active material layer 15 (see FIG. 7). The second adhesive layer 42 extends along the positive electrode uncut portion 13 and the second edge portion 17 of the positive electrode active material layer 15 (see FIG. 7). The third adhesive layer 43 extends along an end of the positive electrode metal current collector exposed portion 12 in the first width direction Y1.

Further, the negative electrode metal current collector 20 has a negative electrode uncut portion 23. A fourth adhesive layer 44 is stacked on a negative electrode metal current collector exposed portion 22. A plurality of stacks 101 was stacked to manufacture a stacked electrode assembly 100. A positive electrode tab (not illustrated) was connected to each of the positive electrode metal current collector exposed portions 12, and a negative electrode tab (not illustrated) was connected to each of the negative electrode metal current collector exposed portions 22. The stacked electrode assembly 100 was sealed in an exterior material together with an electrolytic solution to produce a secondary battery. Note that, although the positive electrode 1 is disposed on the outermost side in the stacking direction of the stacked electrode assembly 100, the positive electrode active material layer 15 is stacked only on the surface of the positive electrode 1 facing the negative electrode 2. Further, for the separator 3, one having a material that did not have an adhesion function in a state in which no electrolyte was present was used (a step of manufacturing the stack 101).

In addition, a secondary battery of a comparative example was produced. A stacked electrode assembly of a secondary battery of the comparative example is different from that of the example in not including the adhesive layer 4 (first adhesive layer 41, second adhesive layer 42, and third adhesive layer 43). In addition, the separator is different from the example in that the separator exhibits an adhesion function in a state where no electrolyte is present.

### (First Test)

As a first test, a current capacity ratio was measured when a charge/discharge rate for the secondary battery was gradually increased from 0.2 C. Hereinafter, the measurement results of the first test in the example and the comparative example are illustrated in Table 1 below.

TABLE 1

| Charge/ | | |
|---|---|---|
| discharge | | Comparative |
| rate | Example | Example |
| 0.2 C | 1.00 | 1.00 |
| 1 C | 1.00 | 0.98 |
| 2 C | 0.99 | 0.91 |
| 3 C | 0.97 | 0.79 |
| 5 C | 0.91 | 0.52 |
| 8 C | 0.76 | — |

In both the example and the comparative example, when the charge/discharge rate was increased, the current capacity ratio was decreased. However, the decrease in the current capacity ratio was suppressed to be smaller in the example. Thus, the use of the adhesive layer 4 (first adhesive layer 41, second adhesive layer 42, and third adhesive layer 43) resulted in less interference with electrolyte impregnation and ion conduction than the use of the separator having an adhesion function. From the above, it has been found that according to the example, it is possible to suppress a voltage drop at the time of high output and to suppress a decrease in the current capacity ratio when the charge/discharge rate is increased.

### (Second Test)

In the second test, 10 secondary batteries were prepared in each of the example and the comparative example. Then, a test was performed as to whether or not ignition occurred simulatively. As a step of causing ignition, the exterior material of the secondary battery was opened, 0.1 g of nickel powder (average particle size: 100 μm) was mixed therein, and the exterior material was sealed again. Thereafter, the secondary battery was rotated and further vibrated. Finally, the secondary battery was pressed from the stacking direction, and whether the secondary battery ignited was observed. In addition, it was also observed whether heat was generated although ignition did not occur. The test results are illustrated in Table 2.

TABLE 2

| | | Comparative |
|---|---|---|
| | Example | Example |
| Ignition | 0/10 | 5/10 |
| Short circuit | 2/10 | 1/10 |
| (heat generated | | |
| but no ignition) | | |

Among the secondary batteries of the example, none ignited (zero out of ten). On the other hand, among the secondary batteries of the comparative example, five batteries ignited (five batteries out of ten batteries ignited). In the secondary battery of the example, two batteries generated heat (two batteries out of ten batteries generated heat). On the other hand, in the secondary battery of the comparative example, one secondary battery generated heat (one secondary battery in ten secondary batteries generated heat). From the above, it was found that the example including the adhesive layer 4 (first adhesive layer 41, second adhesive layer 42, and third adhesive layer 43) makes it difficult for foreign matter to enter the inside of the stacked electrode assembly 100, and can more reliably suppress short circuit between the positive electrode 1 and the negative electrode 2.

Note that the present disclosure may be a combination of configurations below according to an embodiment.

(1)

A secondary battery including a stacked electrode assembly in which a plurality of positive electrodes and a plurality of negative electrodes are alternately stacked with a separator interposed therebetween,
in which the positive electrodes include
a positive electrode metal current collector,
a positive electrode active material layer stacked on the positive electrode metal current collector, and
an adhesive layer that adheres to the separator, and
a region of the positive electrode metal current collector where the positive electrode active material layer is not stacked forms a positive electrode metal current collector exposed portion, and
an edge portion of the positive electrode active material layer includes
a first edge portion adjacent to the positive electrode metal current collector exposed portion when viewed from a stacking direction in which the positive electrode and the negative electrode are stacked, and
a second edge portion disposed on a side opposite to the first edge portion, and
the adhesive layer includes
a first adhesive layer stacked on the positive electrode metal current collector exposed portion and extending along the first edge portion, and
a second adhesive layer extending along the second edge portion.
   (2)

The secondary battery according to (1), in which a part of the first adhesive layer is stacked on at least a part of the first edge portion.

(3)

The secondary battery according to (2), in which a part of the first adhesive layer is stacked on an entirety of the first edge portion.

(4)

The secondary battery according to any one of (1) to (3), in which
a direction in which the positive electrode metal current collector exposed portion is disposed as viewed from the positive electrode active material layer is defined as a first width direction, and
the adhesive layer includes a third adhesive layer extending along an end of the positive electrode metal current collector exposed portion in the first width direction.
   (5)

The secondary battery according to any one of (1) to (4), in which
the positive electrode metal current collector includes
a metal current collector body on which the positive electrode active material layer is stacked,
the positive electrode metal current collector exposed portion, and
a positive electrode uncut portion disposed on a side opposite to the positive electrode metal current collector exposed portion with the metal current collector body interposed therebetween, and
the positive electrode metal current collector exposed portion and the positive electrode uncut portion have a same length in a length direction orthogonal to a width direction in which the metal current collector body, the positive electrode metal current collector exposed portion, and the positive electrode uncut portion are disposed when viewed from the stacking direction, and
the second adhesive layer is stacked on the positive electrode uncut portion.
   (6)

The secondary battery according to (5), in which a part of the second adhesive layer is stacked on at least a part of the second edge portion.

(7)

The secondary battery according to (6), in which a part of the second adhesive layer is stacked on an entirety of the second edge portion.

(8)

The secondary battery according to any one of (1) to (5), in which the second adhesive layer is stacked on the second edge portion.

(9)

The secondary battery according to any one of (1) to (8), in which
the negative electrode includes
a negative electrode metal current collector,
a negative electrode active material layer stacked on the negative electrode metal current collector, and
an adhesive layer, and
a region of the negative electrode metal current collector where the negative electrode active material layer is not stacked forms a negative electrode metal current collector exposed portion, and
the adhesive layer includes a fourth adhesive layer stacked on the negative electrode metal current collector exposed portion.
   (10)

A method for manufacturing a secondary battery, the method including:
an intermediate stack manufacturing step of manufacturing an intermediate stack in which a positive electrode intermediate sheet and a negative electrode intermediate sheet are alternately stacked with a separator intermediate sheet interposed therebetween; and
a segmentation step of segmenting the intermediate stack and manufacturing a stack in which a positive electrode and a negative electrode are alternately stacked with a separator interposed therebetween,
in which the positive electrode intermediate sheet includes
a plurality of positive electrode metal current collector bodies arranged in one direction along the separator intermediate sheet,
a connecting portion that protrudes in the one direction from an edge portion of the positive electrode metal current collector body, is connected to the positive electrode metal current collector body disposed in the one direction, and is cut in the segmentation step,
a plurality of positive electrode active material layers stacked on a plurality of the positive electrode metal current collector bodies, and
an adhesive layer that adheres to the separator intermediate sheet, and
an edge portion of the positive electrode active material layer includes
a first edge portion adjacent to the connecting portion disposed in the one direction, and
a second edge portion adjacent to the connecting portion disposed in a direction opposite to the one direction, and
the adhesive layer includes
a first adhesive layer stacked on the connecting portion and extending along the first edge portion, and
a cutting adhesive layer stacked on the connecting portion and extending along the second edge portion, and
in the segmentation step, the cutting adhesive layer is cut, and the cutting adhesive layer is divided into a second adhesive layer disposed in the one direction and a third adhesive layer disposed in the opposite direction.

### DESCRIPTION OF REFERENCE SYMBOLS

1, 1A, 1B, 1C, 1E: Positive electrode
2, 2D, 2E: Negative electrode
3, 3E: Separator
4, 4A, 4B, 4E: Adhesive layer
10, 10C, 10E: Positive electrode metal current collector
11: Positive electrode metal current collector body
12, 12E: Positive electrode metal current collector exposed portion
13: Positive electrode uncut portion
14: Connecting portion
15: Positive electrode active material layer
16: First edge portion
17: Second edge portion
20, 20E: Negative electrode metal current collector
21: Negative electrode metal current collector body
22, 22E: Negative electrode metal current collector exposed portion
23: Negative electrode uncut portion
24: Connecting portion
25: Negative electrode active material layer
30, 30E: Separator body
31: Protruding piece
41, 41B, 41E: First adhesive layer
42, 42B, 42C, 42E: Second adhesive layer
43: Third adhesive layer
44: Fourth adhesive layer
100: Stacked electrode assembly
101: Stack
104: Long adhesive layer
112: Non-applied region
115: Long positive electrode active material layer
150, 151, 152: Through hole
200: Adhesive body
210: Positive electrode intermediate sheet
220: Negative electrode intermediate sheet
230: Separator intermediate sheet
300: Intermediate stack

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising a stacked electrode assembly in which a plurality of positive electrodes and a plurality of negative electrodes are alternately stacked with a separator interposed therebetween,
wherein the positive electrodes include
a positive electrode metal current collector,
a positive electrode active material layer stacked on the positive electrode metal current collector, and
an adhesive layer that adheres to the separator, and
a region of the positive electrode metal current collector where the positive electrode active material layer is not stacked forms a positive electrode metal current collector exposed portion, and
an edge portion of the positive electrode active material layer includes
a first edge portion adjacent to the positive electrode metal current collector exposed portion when viewed from a stacking direction in which the positive electrode and the negative electrode are stacked, and
a second edge portion disposed on a side opposite to the first edge portion, and
the adhesive layer includes
a first adhesive layer stacked on the positive electrode metal current collector exposed portion and extending along the first edge portion, and
a second adhesive layer extending along the second edge portion.

2. The secondary battery according to claim 1, wherein a part of the first adhesive layer is stacked on at least a part of the first edge portion.

3. The secondary battery according to claim 2, wherein a part of the first adhesive layer is stacked on an entirety of the first edge portion.

4. The secondary battery according to claim 1, wherein
a direction in which the positive electrode metal current collector exposed portion is disposed as viewed from the positive electrode active material layer is defined as a first width direction, and
the adhesive layer includes a third adhesive layer extending along an end of the positive electrode metal current collector exposed portion in the first width direction.

5. The secondary battery according to claim 1, wherein
the positive electrode metal current collector includes
a metal current collector body on which the positive electrode active material layer is stacked,
the positive electrode metal current collector exposed portion, and
a positive electrode uncut portion disposed on a side opposite to the positive electrode metal current collector exposed portion with the metal current collector body interposed therebetween, and
the positive electrode metal current collector exposed portion and the positive electrode uncut portion have a same length in a length direction orthogonal to a width direction in which the metal current collector body, the positive electrode metal current collector exposed portion, and the positive electrode uncut portion are disposed when viewed from the stacking direction, and
the second adhesive layer is stacked on the positive electrode uncut portion.

6. The secondary battery according to claim 5, wherein a part of the second adhesive layer is stacked on at least a part of the second edge portion.

7. The secondary battery according to claim 6, wherein a part of the second adhesive layer is stacked on an entirety of the second edge portion.

8. The secondary battery according to claim 1, wherein the second adhesive layer is stacked on the second edge portion.

9. The secondary battery according to claim 1, wherein
the negative electrode includes
a negative electrode metal current collector,
a negative electrode active material layer stacked on the negative electrode metal current collector, and
an adhesive layer, and
a region of the negative electrode metal current collector where the negative electrode active material layer is not stacked forms a negative electrode metal current collector exposed portion, and
the adhesive layer includes a fourth adhesive layer stacked on the negative electrode metal current collector exposed portion.

10. A method for manufacturing a secondary battery, the method comprising:
an intermediate stack manufacturing step of manufacturing an intermediate stack in which a positive electrode intermediate sheet and a negative electrode intermediate sheet are alternately stacked with a separator intermediate sheet interposed therebetween; and
a segmentation step of segmenting the intermediate stack and manufacturing a stack in which a positive electrode and a negative electrode are alternately stacked with a separator interposed therebetween,
wherein the positive electrode intermediate sheet includes
a plurality of positive electrode metal current collector bodies arranged in one direction along the separator intermediate sheet,
a connecting portion that protrudes in the one direction from an edge portion of the positive electrode metal current collector body, is connected to the positive electrode metal current collector body disposed in the one direction, and is cut in the segmentation step,
a plurality of positive electrode active material layers stacked on a plurality of the positive electrode metal current collector bodies, and
an adhesive layer that adheres to the separator intermediate sheet, and
an edge portion of the positive electrode active material layer includes
a first edge portion adjacent to the connecting portion disposed in the one direction, and
a second edge portion adjacent to the connecting portion disposed in a direction opposite to the one direction, and
the adhesive layer includes
a first adhesive layer stacked on the connecting portion and extending along the first edge portion, and
a cutting adhesive layer stacked on the connecting portion and extending along the second edge portion, and
in the segmentation step, the cutting adhesive layer is cut, and the cutting adhesive layer is divided into a second adhesive layer disposed in the one direction and a third adhesive layer disposed in the opposite direction.
